(19) United States
(12) Patent Application Publication
(10) Pub. No.: US 2025/0097663 A1
(43) Pub. Date: Mar. 20, 2025

(54) SYSTEM FOR PRIORITIZING MONITORING OF LOCATION AND MOVEMENT OF INDIVIDUALS WITHIN A MANUFACTURING ENVIRONMENT

(71) Applicant: Honda Motor Co., Ltd., Tokyo (JP)

(72) Inventors: Vera Fosnot, Plain City, OH (US); Eric Walli, Torrance, CA (US)

(73) Assignee: Honda Motor Co., Ltd., Tokyo (JP)

(21) Appl. No.: 18/369,358

(22) Filed: Sep. 18, 2023

(51) Int. Cl. H04W 4/021; H04W 4/029

(52) U.S. Cl. CPC H04W 4/021; H04W 4/029

(57) ABSTRACT

A system and method for prioritizing monitoring of location and body movement of individuals in a facility is provided. The system and method may use a plurality of tag sensor devices. Each of the plurality of tag sensor devices may be worn by an individual in the facility. A plurality of anchor devices may be positioned around the facility for transferring data to and from each of the plurality of tag sensor devices. A server may monitor a location of each of the plurality of tag sensor devices. The server prioritizes types of data that are received from each of the plurality of tag sensor devices based on a present location of each of the plurality of tag sensor devices.

### BACKGROUND

In a manufacturing environment, it may be beneficial to monitor individuals on the manufacturing floor for health and productivity reasons. Some manufacturing floors may have areas where it may be beneficial to let individuals know of potential hazards. These areas may be restricted during certain times due to the use of automated machinery, exposure to potential hazardous materials, and other manufacturing hazards in order to help mitigate the risk of an event. Unfortunately, some individuals may not recognize an impending event until the environment becomes too precarious.

In a manufacturing environment, it may be beneficial to monitor individuals on the manufacturing floor for productivity reasons. Knowing when an individual is slowing down due to over repetitive motions, heat or other work-related issues may allow a company to find a replacement for this individual in order to prevent the individual from further injuring themselves as well as to keep productivity at an optimum level.

However, in large manufacturing facilities, it may be difficult and may not be cost effective to monitor all the individuals on the manufacturing floor. For example, there may be some individuals who may not work near any potentially hazardous areas, may be walking away from potentially hazardous areas, may not be participating in the manufacturing process, or other non-essential reasons. Monitoring these individuals may be less warranted. Thus, it may be beneficial to balance and prioritize which individuals on the manufacturing floor should be monitored.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a system for prioritizing monitoring of location and body movements is provided. The system may use a plurality of tag sensor devices. Each of the plurality of tag sensor devices may be worn by an individual in the facility. A plurality of anchor devices may be positioned around the facility transferring data to and from each of the plurality of tag sensor devices. A server may monitor a location of each of the plurality of tag sensor devices. The server may prioritize types of data that are received from each of the plurality of tag sensor devices based on a present location of each of the plurality of tag sensor devices.

According to another embodiment of the disclosure, a method for prioritizing monitoring of location and body movement of individuals in a facility is provided. The method may receive location data from a plurality of tag sensor devices located in a manufacturing facility. The method may prioritize types of data that are received from each of the plurality of tag sensor devices based on a present location of each of the plurality of tag sensor devices.

According to another embodiment of the disclosure, a non-transitory computer-readable medium is provided. The non-transitory computer-readable medium may have stored thereon computer-implemented instructions that, when executed by an electronic device, causes the electronic device to execute operations. The operations may include dividing the manufacturing facility into a plurality of zones. The operation may further include assigning a priority level to each of the plurality of zones. The operation may further include receiving location data from a plurality of tag sensor devices located in the manufacturing facility. The operation may further include prioritizing types of data that are received from each of the plurality of tag sensor devices based on a present location of each of the plurality of tag sensor devices. The operation may further include transmitting the data from different tag sensor devices at different rates based on a priority level of each of the plurality of tag sensor devices.

### BRIEF DESCRIPTION OF THE DRAWINGS

FIG. 1 is a block diagram that illustrates an exemplary network environment for prioritizing monitoring of location and movement of individuals in a manufacturing facility, in accordance with an embodiment of the disclosure.

FIG. 2 is a diagram that illustrates an exemplary screen view of an electronic device showing workers being monitored in proximity of a hazardous area within the manufacturing facility, in accordance with an embodiment of the disclosure.

FIG. 3 is a diagram that illustrates an exemplary screen view of an electronic device showing workers being monitored in proximity of a hazardous area within the manufacturing facility, in accordance with an embodiment of the disclosure.

FIG. 4 is a perspective view that illustrates an exemplary monitoring device to worn by individuals on the manufacturing floor, in accordance with an embodiment of the disclosure.

FIG. 5 is a perspective view that illustrates an exemplary monitoring device to worn by individuals on the manufacturing floor, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed electronic system and method for prioritizing monitoring of individuals within a manufacturing facility. Exemplary aspects of the disclosure may provide a system to monitor individuals within a manufacturing facility. Monitoring of individuals within a predefined area of the manufacturing facility may be prioritized due to potential health and productivity reasons. When an individual enters one of the predefined areas on the manufacturing floor, different information may be monitored and collected for health and productivity reasons as opposed to those not within the predefined area.

Reference will now be made in detail to specific aspects or features, examples of which are illustrated in the accompanying drawings. Wherever possible, corresponding, or similar reference numbers will be used throughout the drawings to refer to the same or corresponding parts.

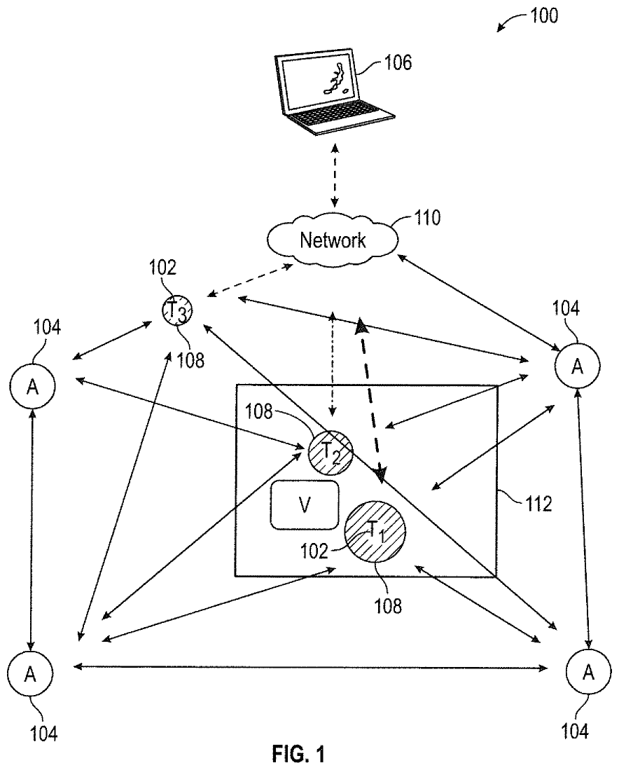

FIG. 1 is a block diagram that illustrates an exemplary network environment for prioritized monitoring of individuals within a manufacturing facility 100. There is shown a network environment 100. The network environment 100 may include one or more tag sensors 102, one or more anchors 104 and a server 106. The tag sensors 102 may be worn by individuals 108 located within a manufacturing facility. The network system 100 may prioritize the monitoring of individuals 108 who are approaching or are within a predefined zone 112 located within the manufacturing facility. As an individual 108 approaches and/or is located within the predefined zone 112, the tag sensors 102 may monitor and record additional data for health and/or productivity reasons. The tag sensors 102 may communicate with the server 106 via a communication network 110. In at least one embodiment, the tag sensor 102 may communicate with the server 106 via one or more anchors 104.

The tag sensors 102 may include suitable logic, circuitry, interfaces, and/or code that may be configured to monitor a present location and movement of body parts of the individual 108 who may be wearing the tag sensor 102. By way of example, and not limitation, the tag sensors 102 may monitor arm bending and/or other arm movements, leg bending and/or other leg movements and torso bending and/or other torso movements. The present disclosure may also be applicable to other types of body part movements, without a departure from the scope of the present disclosure. The data monitored may be recorded and transmitted to the server 106. By way of example, and not limitation, the tag sensors 102 may transmit the data monitored to the server 106 either directly via the communication network 110 or via one or more of the anchors 106 who may transmit the data via the communication network 110.

The anchors 104 may include suitable logic, circuitry, interfaces, and/or code that may be configured to receive the data from the tag sensors 102 and to transmit the data to the server 106 via the wireless communication network 110. The anchors 104 may transmit data from the server 106 to the different tag sensors 104 via the via the wireless communication network 110. The anchors 104 may be a network node providing a connection point between the tag sensors 102 and the server 106 allowing the transfer of data to and from the tag sensors 102 and the server 106. The anchor 104 may be a switch, a router, or other communication device that may be able to properly route the data to the correct device. In at least one embodiment, the network environment 100 may use a plurality of anchors 104. The anchors 104 may be positioned throughout the manufacturing floor to provide communication coverage around the manufacturing floor.

The server 106 may include suitable logic, circuitry, interfaces, and/or code that may be configured to receive data from the different tag sensors 102. The server 106 may be located within the manufacturing facility or at a remote location. The data received by the server 106 may include location data from the different tag sensors 102. Depending on the location data received, the server 106 may execute instructions to request that body part movement data be recorded and transmitted by requisite tag sensors 102 to the server 106. The server 106 may analyze the body part movement data for health and productivity reasons. The server 106 may execute operations through web applications, cloud applications, Hypertext Transfer Protocol (HTTP) requests, repository operations, file transfer, and the like. Example implementations of the server 106 may include, but are not limited to, a database server, a file server, a web server, an application server, a mainframe server, a cloud computing server, or a combination thereof. In at least one embodiment, the server 108 may be implemented as a plurality of distributed cloud-based resources by use of several technologies that are well known to those ordinarily skilled in the art.

The communication network 110 may include a medium through which the tag sensors 102, the anchors 104, and the server 106 may communicate with each other. The communication network 110 may be established in accordance with Institute of Electrical and Electronics Engineers (IEEE) standards for infrastructure mode (Basic Service Set (BSS) configurations), or in some specific cases, in ad hoc mode (Independent Basic Service Set (IBSS) configurations).

The communication network 110 may be a wired connection or a wireless connection. Examples of the communication network 110 may include, but may not be limited to, the Internet, a cloud network, a Cellular or Wireless Mobile Network (such as a Long-Term Evolution and 5G New Radio), a Wi-Fi network, a PAN, a Local Area Network (LAN), or a Metropolitan Area Network (MAN). The tag sensors 102, the anchors 104, and the server 106 may be configured to connect to the communication network 110 in accordance with various wired communication protocols and wireless communication protocols. Examples of the wire and wireless communication protocols may include, but are not limited to, at least one of a TCP/IP, UDP, HTTP, FTP, Zig Bee, EDGE, IEEE 802.11, Li-Fi, IEEE 802.16, IEEE 802.11s, IEEE 802.11g, multi-hop communication, wireless AP, D2D communication, cellular communication protocols, and BT communication protocols.

For a particular pair of nodes (e.g., the tag sensors 102, the anchors 104, and the server 106), the wireless communication network 110 may be established to use a specific type of communication, such as a short-range communication or a long-range communication. The short-range communication may be a point-to-point communication, a point-to-point line-of-sight (LOS) communication, or a point-to-multipoint communication. Examples of protocols for the short-range communication may include, but are not limited to, Radio Frequency Identification (RFID), Wireless USB, Dedicated Short Range Communications (DSRC), and Near Field Communication (NFC) (e.g., NFC Peer-to-Peer), Bluetooth®, or Bluetooth® Low Energy (BLE). Other examples of protocols may include, but are not limited to, ZigBee, Personal Area Network (PAN), Wi-Max, Wireless Metropolitan Area Networks (WMAN), and Local Multipoint Distribution Service.

In operation, individuals 108 located within a manufacturing facility may be fitted with a different tag sensor 102. The tag sensors 102 may be used to provide location data of the different individuals 108. The location of each tag sensor 102 may be determined in different ways. For example, the anchors 104 may be GPS-enabled such that a controller within the respective anchor 104 may be able to precisely determine the position of the respective anchor 104. Based on wireless communications between a respective tag sensor 102 and one or more of the anchors 104, the location of the individual 108 with the respective tag sensor 102 may be determined. If the anchors 104 are not GPS enabled, respective tag sensors 102 may transmit a wireless signal to one of more of the anchors 104. The location of the respective tag sensor 102 and hence the individual 108 may be determined through triangulation. The above are given as examples and the present disclosure is not limited to the specific location methods disclosed above.

The server 106 may receive the location data of the different tag sensors 102. The server 106 may prioritize the monitoring of certain individuals 108 based on the current location of each tag sensor 102. For higher priority tag sensors 102, the server 106 may signal those high priority tag sensors 102 to monitor and transmit the present location and additional data such as movement of body parts of the individual 108 who may be wearing the high priority tag sensors 102 for health and/or productivity reasons.

In FIG. 1, three different individuals 108 may be shown on the manufacturing area. This may be shown as an example as the network environment 100 may monitor any number of individuals 108 on the manufacturing area. Each individual 108 has an associated tag sensor 102 labeled as T₁, T₂ and T₃ respectively. The tag sensors 102 may be embedded in a vest or other wearable. The server 106 may prioritize the data monitored and collected from each of the tag sensors 102 based on the location of the tag sensor 102. For example, the tag sensor 102 labeled as T₁ and T₂ may be placed at a high priority since both tag sensors labeled as T₁ and T₂ may be located within the predefined zone 112. The predefined zone 112 may be an area having potential hazards. For example, the predefined zone 112 may have potential hazards such as the use of automated machinery, exposure to potential hazardous materials, or other potentially hazardous manufacturing processes. The server 106 may signal the tag sensors 102 labeled as T₁ and T₂ to monitor and transmit additional data for health and/or productivity such as the present location and movement of body parts of the individuals 108 who may be wearing the tag sensors 102 labeled as T₁ and T₂. The tag sensor 102 labeled as T₃ may be placed at a low priority since the tag sensor 102 labeled as T₃ is not located within the predefined zone 112. Since the tag sensor 102 labeled as T₃ is placed at a lower priority, the server 106 may signal the tag sensor 102 labeled as T₃ to record and transmit just the location data thereby lowering power consumption of the tag sensor 102 labeled as T₃.

In accordance with an embodiment, the server 106 may prioritize the data monitored and collected from each of the tag sensors 102 based on the location of the tag sensor 102 and the job duties of the individuals 108. For example, the tag sensors 102 labeled as T₁ and T₂ may both be in the predefined zone 112. However, the server 106 may place a higher priority on the tag sensor 102 labeled as T₁ since the individual 108 wearing the tag sensor labeled as T₁ may be working on a manufacturing item V located within the predefined zone 112 while the individual 108 wearing the tag sensor labeled as T₂ may not be performing any manufacturing task and may just be observing.

Since both individuals 108 who may be wearing the tag sensors 102 labeled as T₁ and T₂ respectively may be located within the predefined zone 112. The server 106 may signal, or provide information to, the tag sensors 102 labeled as T₁ and T₂ to monitor and transmit data related to the present location and movement of body parts of the individuals 108 who may be wearing the tag sensors 102 labeled as T₁ and T₂. However, since the tag sensor 102 labeled as T₁ may be at a higher priority than the tag sensor 102 labeled as T₂, the tag sensor 102 labeled as T₁ may be transmitted at a higher frequency than that of the tag sensor 102 labeled as T₂. For example, the tag sensor 102 labeled as T₁ may transmit location and body movement data every second while the tag sensor 102 labeled as Ta may transmit location and body movement data every three (3) seconds thereby lowering power consumption of the tag sensor 102 labeled as T₂.

In accordance with an embodiment, as shown in FIG. 1, the level of prioritization may be illustrated by the size of the tag sensor 102. The tag sensor 102 with the highest priority may be the largest in size, with the size of the tag sensor 102 decreasing as the priority level decreases. For example, the tag sensor 102 labeled as T₁ may have the highest priority. Thus, the circle surrounding the label T₁ may be the largest in size. The tag sensors 102 labeled as T₂, being less of a priority than tag sensors 102 labeled as T₁, may be smaller in size than tag sensors 102 labeled as T₁. The tag sensor 102 labeled as T₃ may have the lowest priority and thus may be smallest in size.

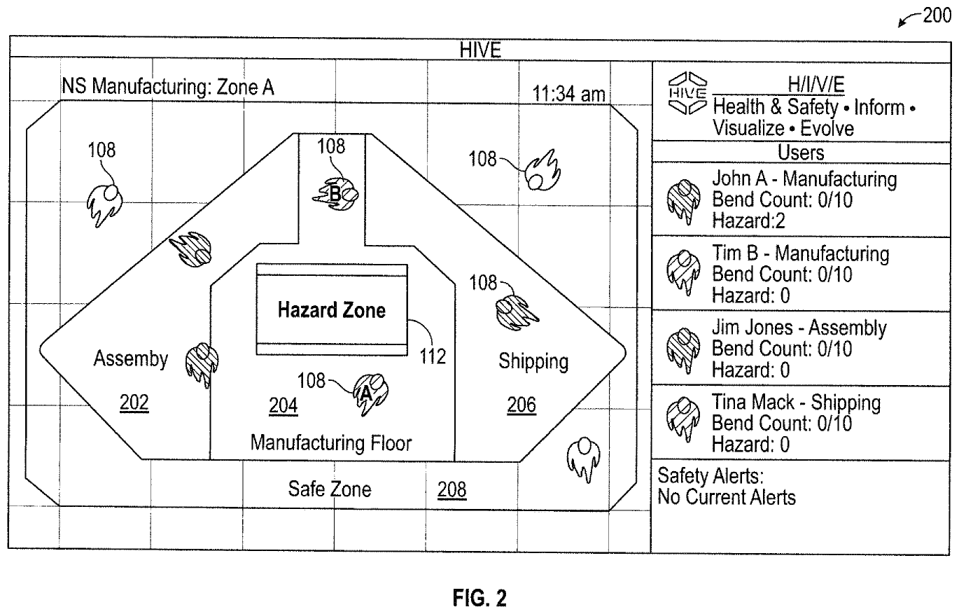

Referring to FIG. 2, an exemplary screen view 200 of an electronic device showing operation of the network environment 100 of FIG. 1 is shown. FIG. 2 may be explained in conjunction with elements from FIG. 1. In accordance with an embodiment, the manufacturing zone 200 may be divided into an assembly area 202, a manufacturing area 204, a shipping area 206 and a safe area 208. The manufacturing zone 200 may have a predefined zone 112 which may be an area having potential hazards. For example, the predefined zone 112 may have potential hazards such as the use of automated machinery, exposure to potential hazardous materials, or other potentially hazardous manufacturing processes.

In accordance with an embodiment, prioritization of monitoring each individual 108 may be based on the area of the manufacturing floor 200 where the individual 108 is located. For example, the manufacturing area 204 may be labeled as having the highest priority, the assembly area 202 as the second highest priority, and the shipping area 206 as the third highest priority. The safe area 210 may be labeled as having the lowest priority. In accordance with one embodiment, individuals 108 located in the higher priority areas may have their tag sensors 102 monitor and transmit location data and body movement data while individuals 108 in the lowest priority areas may only monitor and transmit location data.

In accordance with one embodiment, the higher priority area may sample and transmit data at a higher frequency than those of lower priority areas. For example, tag sensors 102 located in the manufacturing area 204 may monitor and transmit data at a higher frequency rate than tag sensors 102 of individuals 108 located in the assembly area 202, the shipping area 206 and the safe area 210. Tag sensors 102 located in the assembly area 204 may monitor and transmit data at a higher frequency rate than tag sensors 102 of individuals 108 located in the shipping area 206 and the safe area 210. Tag sensors 102 located in the shipping area 206 may monitor and transmit data at a higher frequency rate than tag sensors 102 of individuals 108 located in the safe area 210.

In accordance with one embodiment, prioritization of the recording and transmitting of data may be based on the job responsibilities of the individual 108. For example, in FIG. 2, there are two individuals 108 located in the manufacturing area 204. One individual 108 labeled as A may have a job function which may require working in the predefined zone 112 which is labeled as a Hazard Zone. The other individual 108 labeled as B may be an observer and may not have to work or enter the predefined zone 112. Since the individual 108 labeled as A may have to enter the predefined zone 112 for work and the individual 108 labeled as B does not, the individual 108 labeled as A may be given a higher priority than the individual 108 labeled as B. Thus, the tag sensor 102 for the individual 108 labeled as A may monitor and transmit data at a higher frequency than tag sensors 102 of individually 108 labeled as B.

In accordance with one embodiment, the network environment 100 of FIG. 1 may be used to reduce potential injuries of the individuals 108 being monitored on the manufacturing zone 200. As shown in FIG. 2, the network environment 100 may monitor the number of times an individual 108 may enter the predefined zone 112 labeled as a Hazard Zone. In some work environments, individuals 108 may be limited to the number of times per shift/hour they may enter the predefined zone 112 labeled as a Hazard Zone for health reasons. By monitoring the number of times each individual 108 may enter the predefined zone 112 labeled as a Hazard Zone, the tag sensor 102 may warn an individual 108 if they will be exceeding a predetermine limit. For example, in FIG. 2, the individual 108 labeled as A has entered the predefined zone 112 labeled as a Hazard Zone two (2) times. If the maximum limit is ten (10) times per hour, the tag sensor 102 associated with individual 108 labeled as A may emit an audible and/or visual signal when the individual 108 labeled as A exceeds a predefined number of entrances into the predefined zone 112. In accordance with one embodiment, the tag sensor 102 associated with individual 108 labeled as A may emit an audible and/or visual signal after a predetermined amount of time has passed indicating that the individual 108 labeled as A may go back into the predefined zone 112 labeled as a Hazard Zone.

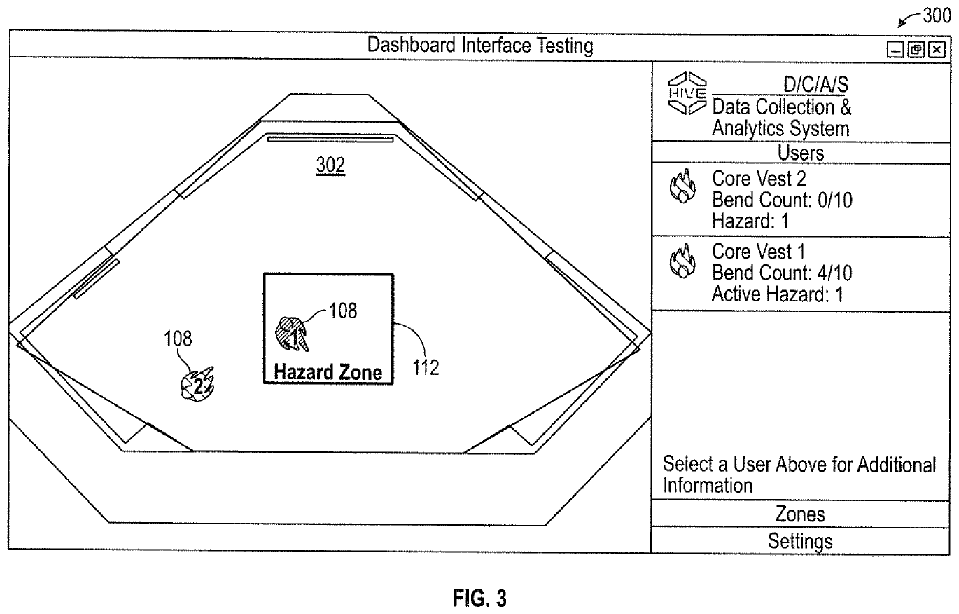

Referring to FIG. 3, an exemplary screen view 300 of an electronic device showing operation of the network environment 100 of FIG. 1 may be shown. FIG. 3 may be explained in conjunction with elements from FIG. 1. In accordance with one embodiment, the network environment 100 of FIG. 1 may be used to reduce potential injuries and maintain productivity of the individuals 108 being monitored on the manufacturing zone 302. The manufacturing floor 302 may have a predefined zone 112 labeled as a Hazard Zone. Each individual 108 on the manufacturing floor 302 may have a high priority. The tag sensors 102 for each individual 108 on the manufacturing floor 302 may monitor location and body part movements. By way of example, and not limitation, the tag sensor 102 may monitor and transmit data relating to arm bending and/or other arm movements, leg bending and/or other leg movements and torso bending and/or other torso movements. The present disclosure may also be applicable to other types of body part movements, without a departure from the scope of the present disclosure.

In a manufacturing environment, the individual 108 on the manufacturing floor 302 may have to perform a repetitive motion during the manufacturing process. The server 106 may analyze the data from the tag sensors 102 of the individuals 108 on the manufacturing floor 302 for health and productivity. For example, in the embodiment shown in FIG. 3, the individual 108 labeled as Core Vest 1 may have to bend their torso to install a widget in a manufactured device. The individual 108 labeled as Core Vest 1 may have to install twelve (12) widgets per hour. The server 106 may analyze the data from the tag sensors 102 of the individuals 106 labeled as Core Vest 1 to determine if productivity will remain stable and if not, whether there may be a health issue with the individuals 106 labeled as Core Vest 1.

In this embodiment, the server 106 may send notifications to the individuals 108 labeled as Core Vest 1, a supervisor of the individuals 106 labeled as Core Vest 1, or others who may be responsible for the manufacturing process should the server 106 identify an issue. For example, in the above example, if the server 106 monitors that the individuals 108 labeled as Core Vest 1 has only performed six (6) torso bends in 45 minutes, the server 106 may send notifications to the individuals 106 labeled as Core Vest 1, a supervisor of the individuals 108 labeled as Core Vest 1, or others who may be responsible for the manufacturing process that productivity is falling behind schedule.

In accordance with one embodiment, the server 106 may analyze the data transmitted by the tag sensors 102 of the individual 106 labeled as Core Vest 1 to see whether the individual 106 labeled as Core Vest 1 has in the last three hours gone from twelve (12) torso bends/hour, to ten (10) torso bends/hour, to eight (8) torso bends/hour indicating that production may be falling behind schedule and that the individual 108 labeled as Core Vest 1 may have health issues from the reputative bending of the torso as the bending rate is continually decreasing.

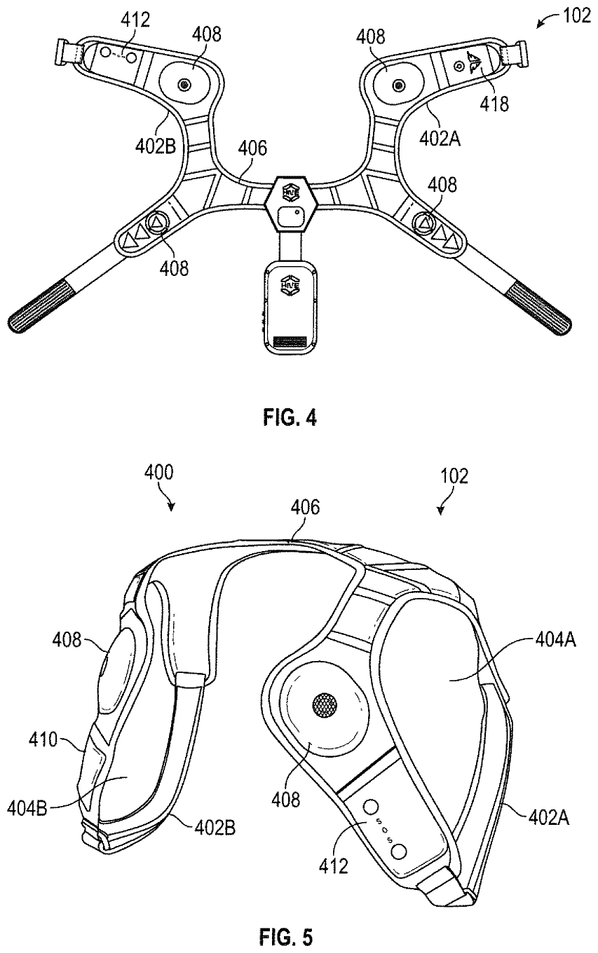

Referring to FIGS. 4-5, an exemplary tag sensor 102 of the network environment 100 of FIG. 1 may be shown. FIGS. 4-5 may be explained in conjunction with elements from FIG. 1. In accordance with one embodiment, tag sensor 102 may have a vest 400. The vest 400 may have a strap 406. A pair of “C” shaped members 402A, 402B may be coupled to the strap 406 with one of the “C” shaped members 402A, 402B coupled to each end of the strap 406. The ends of each “C” shaped members 402A, 402B may be attached together to form adjustable loops 404A, 404B respectively. Each arm of an individual 106 may be positioned through respective adjustable loops 404A, 404B to secure the vest 400 on the individual 108.

A plurality of sensors 408 may be positioned on each of the “C” shaped members 402A, 402B. The sensors 408 may be movement sensors, location sensors, temperature sensors, as well as other sensors to measure different characteristics of the individual 108. An alarm unit 410 may be attached to one of the “C” shaped members 402A, 402B. The alarm unit 410 may be used to supply a visual and/or audible notice to the individual 108. In accordance with one embodiment, the server 106 may send a signal to the alarm unit 410 when the server 106 determines an issue with the individual 106. For example, the server 106 may send a signal to the alarm unit 408 when the server 106 determines that the production of the individual 106 is behind a predetermined level, when the individual 106 has been in a predefined zone 112 over a predetermined time limit, as well as other issues related to the individual 108. A panic button 412 may be attached to one of the “C” shaped members 402A, 402B. The panic button 412 may be used for the individual 108 to send a signal to the server 106 that the individual 108 is in distress. For example, the individual 108 may press the panic button 412 when the individual 108 has fallen and is unable to get up, the individual 108 has been injured, or for other emergency situations.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

What is claimed is:

1. A system for prioritizing monitoring of location and body movements, the system comprising:
a plurality of tag sensor devices;
a plurality of anchor devices transferring data to and from each of the plurality of tag sensor devices; and
a server monitoring a location of each of the plurality of tag sensor devices, the server prioritizing types of data that are received from each of the plurality of tag sensor devices based on a present location of each of the plurality of tag sensor devices.

2. The system of claim 1, wherein the plurality of anchor devices are positioned within a facility, the facility divided into a plurality of zones wherein each of the plurality of zones is given a different priority level, the server prioritizing types of data that are received from each of the plurality of tag sensor devices based on types of zones of the plurality of zones each of the plurality of tag sensor devices is located.

3. The system of claim 1, wherein the plurality of tag sensor devices transmits the data to the server at different rates based on a priority level of each of the plurality of tag sensor devices.

4. The system of claim 1, wherein the server prioritizes types of data that are received from each of the plurality of tag sensor devices based on a present location of each of the plurality of tag sensor devices and a job function associated with a corresponding tag sensor device.

5. The system of claim 1, wherein the plurality of anchor devices are positioned within a facility, the facility having a predefined zone and the server recoding a number of times a tag sensor device has entered the predefined zone, the server sending information to the tag sensor device when the number of times the corresponding individual has entered the predefined zone exceeds a predetermined threshold.

6. The system of claim 1, wherein the server receives location and body movement data from each of the plurality of tag sensor devices having a highest priority by the server.

7. The system of claim 1, wherein the server received location and body movement data from each of the plurality of tag sensor devices having a highest priority by the server, the server sending a signal that productivity is lessening when the body movement data is below a predefined level.

8. The system of claim 7, wherein the server analyzes the body movement data for injury prevention, the server sending a signal of a potential injury when the body movement data continuously falls for multiple time periods.

9. The system of claim 7, wherein the body movement data comprises arm bending, other arm movements, leg bending, other leg movements, torso bending and other torso movements.

10. A method for prioritizing monitoring of location and body movements in a manufacturing facility, comprising:
receiving location data from a plurality of tag sensor devices located in the manufacturing facility;
prioritizing types of data that are received from each of the plurality of tag sensor devices based on a present location of each of the plurality of tag sensor devices.

11. The method of claim 10, comprising:
dividing the manufacturing facility into a plurality of zones;
assigning a priority level to each of the plurality of zones; and
prioritizing types of data that are received from each of the plurality of tag sensor devices based on what zone of the plurality of zones each of the plurality of tag sensor devices is located.

12. The method of claim 10, comprising transmitting the data from different tag sensor devices at different rates based on a priority level of each of the plurality of tag sensor devices.

13. The method of claim 10, comprising prioritizing types of data that are transmitted from each of the plurality of tag sensor devices based on a present location of each of the plurality of tag sensor devices and a job function associated with a corresponding tag sensor device.

14. The method of claim 10, comprising:
defining a predefined zone within the manufacturing facility;
monitoring a number of times a tag sensor device has entered the predefined zone; and
sending information to the tag sensor device when the number of times the corresponding individual has entered the predefined zone exceeds a predetermined threshold.

15. The method of claim 10, comprising:
transmitting location and body movement data from each of the plurality of tag sensor devices having a highest priority; and
analyzing the body movement data to maintain productivity at a predefined level and for injury prevention, the server sending a signal that productivity is lessening when the body movement data is below a predefined level and the server sending a signal of a potential injury when the body movement data continuously falls for multiple time periods.

16. The method of claim 15, wherein the body movement data comprises arm bending, other arm movements, leg bending, other leg movements, torso bending and other torso movements.

17. A non-transitory computer-readable medium having stored thereon computer implemented instructions that, when executed by an electronic device, causes the electronic device to execute operations, the operations comprising:
dividing the manufacturing facility into a plurality of zones;
assigning a priority level to each of the plurality of zones;
receiving location data from a plurality of tag sensor devices located in the manufacturing facility;
prioritization types of data that are received from each of the plurality of tag sensor devices based on a present location of each of the plurality of tag sensor devices; and
transmitting the data from different tag sensor devices at different rates based on a priority level of each of the plurality of tag sensor devices.

18. The non-transitory computer-readable medium of claim 17, the operations comprising prioritization of types of data that are transmitted from each of the plurality of tag sensor devices based on a present location of each of the plurality of tag sensor devices and a job function associated with a corresponding tag sensor device.

19. The non-transitory computer-readable medium of claim 17, the operations comprising:
defining a predefined zone within the manufacturing facility;
monitoring a number of times a tag sensor device has entered the predefined zone; and
sending information to the tag sensor device when the number of times the corresponding individual has entered the predefined zone exceeds a predetermined threshold.

20. The non-transitory computer-readable medium of claim 17, the operations comprising:
transmitting location and body movement data from each of the plurality of tag sensor devices having a highest priority; and
analyzing the body movement data to maintain productivity at a predefined level and for injury prevention, the server sending a signal that productivity is lessening when the body movement data is below a predefined level and the server sending a signal of a potential injury when the body movement data continuously falls for multiple time periods.
